(19) United States
(12) Patent Application Publication
(10) Pub. No.: US 2013/0241821 A1
(43) Pub. Date: Sep. 19, 2013

(54) IMAGE PROCESSING SYSTEM, IMAGE PROCESSING METHOD, AND STORAGE MEDIUM STORING IMAGE PROCESSING PROGRAM

(71) Applicants: Yuriko Hiyama, Tokyo (JP); Tomoyuki Oosaka, Tokyo (JP)

(72) Inventors: Yuriko Hiyama, Tokyo (JP); Tomoyuki Oosaka, Tokyo (JP)

(73) Assignee: NEC CORPORATION, Tokyo (JP)

(21) Appl. No.: 13/822,992

(22) PCT Filed: Sep. 26, 2011
(86) PCT No.: PCT/JP2011/071801

§ 371 Date: May 21, 2013

(30) Foreign Application Priority Data
Nov. 10, 2010 (JP) 2010-251679

(51) Int. Cl. G06F 3/01

(52) U.S. Cl. CPC G06F 3/017
USPC 345/156

(57) ABSTRACT

This invention relates to an image processing apparatus that displays an image for plural persons and has a higher operationality for a person who is viewing the image. The apparatus includes an image display unit that displays an image, a sensing unit that senses an image of plural persons gathered in front of the image display unit, a gesture recognition unit that recognizes, from the image sensed by the sensing unit, a gesture performed by each of the plural persons for the image displayed on the image display unit, and a display control unit that makes a display screen transit based on a recognized result by the gesture recognition unit.

### TECHNICAL FIELD

The present invention relates to a technique of giving information to general public.

### BACKGROUND ART

As a display system for giving information to general public, a system using digital signage is known. For example, patent literature 1 discloses a technique of judging the attention level to a display screen based on the attention time and the distance from the screen obtained from an image sensed by a camera and giving information suitable for a person who is paying attention.

### CITATION LIST

### Patent Literature

Patent literature 1: Japanese Patent Laid-Open No. 2009-176254

### SUMMARY OF INVENTION

### Technical Problem

However, although the digital signage described in patent literature 1 implements a mechanism for displaying an image for plural persons, the operation is done by causing one user to touch the screen. That is, the operationality is not high for the user.

It is an object of the present invention to provide a technique of solving the above-described problem.

### Solution to Problem

In order to achieve the above-described object, a system according to the present invention comprises:
an image display unit that displays an image;
a sensing unit that senses an image of plural persons gathered in front of the image display unit;
a gesture recognition unit that recognizes, from the image sensed by the sensing unit, a gesture performed by each of the plural persons for the image displayed on the image display unit; and
a display control unit that makes the display screen transit based on a recognized result by the gesture recognition unit.

In order to achieve the above-described object, an apparatus according to the present invention comprises:
a gesture recognition unit that recognizes, from an image sensed by a sensing unit, a gesture performed by each of plural persons gathered in front of an image display unit for an image displayed on an image display unit; and
a display control unit that makes a display screen transit based on a recognized result by the gesture recognition unit.

In order to achieve the above-described object, a method according to the present invention comprises:
an image display step of displaying an image on an image display unit;
a sensing step of sensing an image of plural persons gathered in front of the image display unit;
a gesture recognition step of recognizing, from the image sensed in the sensing step, a gesture performed by each of the plural persons for an image displayed on the image display unit; and
a display control step of making a display screen transit based on a recognized result in the gesture recognition step.

In order to achieve the above-described object, a storage medium according to the present invention stores a program that causes a computer to execute:
an image display step of displaying an image on an image display unit;
a gesture recognition step of recognizing, from an image of plural persons gathered in front of the image display unit, a gesture performed by each of the plural persons; and
a display control step of making a display screen transit based on a recognized result in the gesture recognition step.

### Advantageous Effects of Invention

According to the present invention, it is possible to implement an apparatus that displays an image for plural persons and has a higher operationality for a person who is viewing the image.

### BRIEF DESCRIPTION OF DRAWINGS

FIG. 1 is a block diagram showing the arrangement of an information processing apparatus according to the first embodiment of the present invention;

FIG. 2 is a block diagram showing the arrangement of an image processing system including an information processing apparatus according to the second embodiment of the present invention;

FIG. 3 is a block diagram showing the hardware structure of the information processing apparatus according to the second embodiment of the present invention;

FIG. 4 is a view showing the structure of data of sensed hands according to the second embodiment of the present invention;

FIG. 5 is a view showing the structure of a gesture DB according to the second embodiment of the present invention;

FIG. 6A is a view showing the structure of a table according to the second embodiment of the present invention;

FIG. 6B is a view showing the structure of a table according to the second embodiment of the present invention;

FIG. 6C is a view showing the structure of a table according to the second embodiment of the present invention;

FIG. 6D is a view showing the structure of a table according to the second embodiment of the present invention;

FIG. 7 is a flowchart showing the processing sequence of the information processing apparatus according to the second embodiment of the present invention;

FIG. 8 is a block diagram showing the arrangement of an information processing apparatus according to the third embodiment of the present invention;

FIG. 9 is a view showing the structure of an attribute judgment table according to the third embodiment of the present invention;

FIG. 10 is a block diagram showing the structure of an informing program DB according to the third embodiment of the present invention;

FIG. 11 is a view showing the structure of an informing program selection table according to the third embodiment of the present invention;

FIG. 12 is a flowchart showing the processing sequence of the information processing apparatus according to the third embodiment of the present invention; and

FIG. 13 is a block diagram showing the arrangement of an image processing system according to the fourth embodiment of the present invention.

### DESCRIPTION OF EMBODIMENTS

The embodiments of the present invention will now be described in detail with reference to the accompanying drawings. Note that the constituent elements described in the following embodiments are merely examples, and the technical scope of the present invention is not limited by them.

### First Embodiment

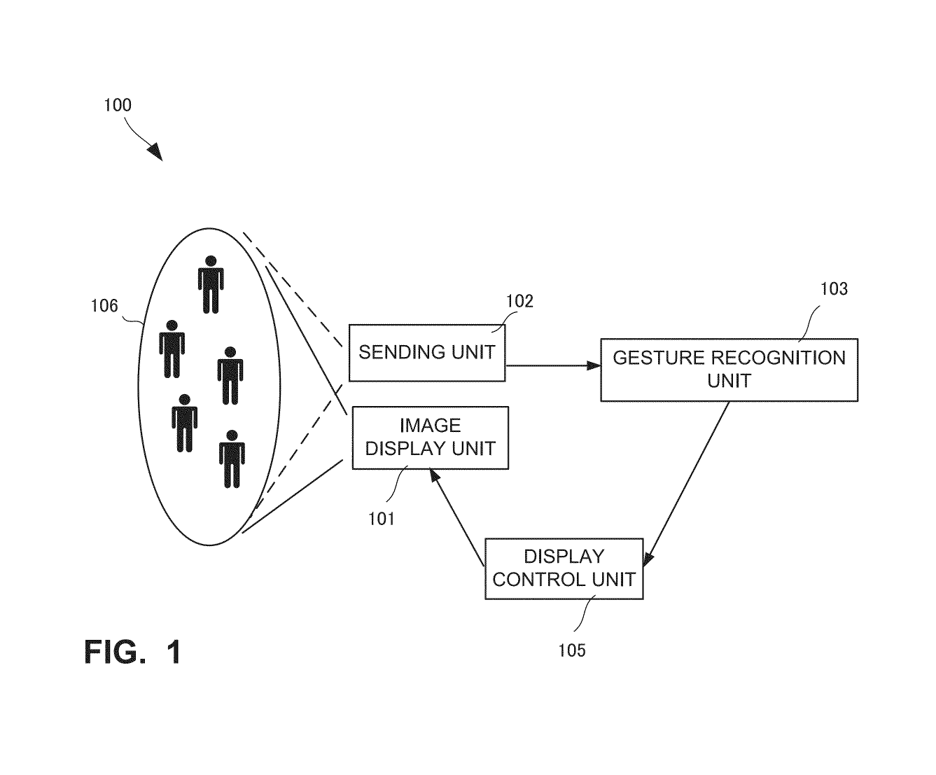

An image processing system 100 according to the first embodiment of the present invention will be described with reference to FIG. 1. The image processing system 100 includes an image display unit 101 that displays an image, and a sensing unit 102 that senses an image of plural persons 106 gathered in front of the image display unit 101. The image processing system 100 also includes a gesture recognition unit 103 that recognizes, from the image sensed by the sensing unit 102, a gesture performed by each of the plural persons 106 for the image displayed on the image display unit 101. The image processing system 100 also includes a display control unit 105 that makes the display screen of the image display unit 101 transit based on the recognized result by the gesture recognition unit 103.

According to this embodiment, it is possible to implement an apparatus that displays an image for plural persons and has a higher operationality for a person who is viewing the image.

### Second Embodiment

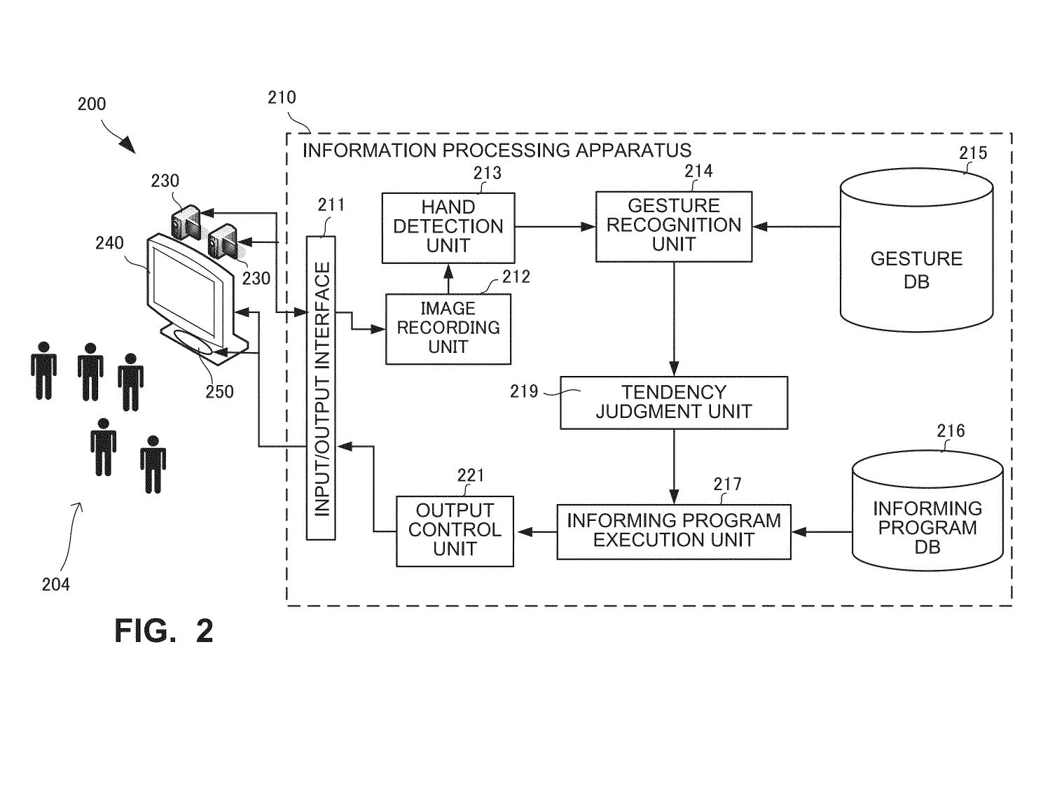

An image processing system 200 according to the second embodiment of the present invention will be described with reference to FIGS. 2 to 7. The image processing system 200 includes a display apparatus that simultaneously displays an image for plural persons. The image processing system recognizes the staying time, face direction, and hand gesture of each of the plural persons in front of the image display unit, parameterizes them, totally judges the parameters, and calculates the attention level of the whole passersby to the display apparatus (digital signage).

### <System Arrangement>

FIG. 2 is a block diagram showing the arrangement of the image processing system 200 including an information processing apparatus 210 according to the second embodiment. Note that although FIG. 2 illustrates the stand-alone information processing apparatus 210, the arrangement can also be extended to a system that connects plural information processing apparatuses 210 via a network. A database will be abbreviated as a DB hereinafter.

The image processing system 200 shown in FIG. 2 includes the information processing apparatus 210, a stereo camera 230, a display apparatus 240, and a speaker 250. The stereo camera 230 can sense plural persons 204 of general public and send the sensed image to the information processing apparatus 210, and also focus on a target person under the control of the information processing apparatus 210. The display apparatus 240 informs a publicity or advertising message in accordance with an informing program from the information processing apparatus 210. In this embodiment, a screen including an image to induce a response using gestures is displayed for the plural persons 204 in or prior to the publicity or advertising message. Upon confirming a person who has responded in the image from the stereo camera 230, an interactive screen with the person who has responded using gestures is output. The speaker 250 outputs auxiliary sound to prompt interaction using gestures with the screen of the display apparatus 240 or the person 204 who has responded.

### <Functional Arrangement of Information Processing Apparatus>

The information processing apparatus 210 includes an input/output interface 211, an image recording unit 212, a hand detection unit 213, a gesture recognition unit 214, a gesture DB 215, an informing program DB 216, an informing program execution unit 217, and an output control unit 221. The information processing apparatus 210 also includes a tendency judgment unit 219.

Note that the information processing apparatus 210 need not always be a single apparatus, and plural apparatuses may implement the functions shown in FIG. 2 as a whole. Each functional component will be explained in accordance with a processing sequence according to this embodiment.

The input/output interface 211 implements the interface between the information processing apparatus 210 and the stereo camera 230, the display apparatus 240, and the speaker 250.

First, the informing program execution unit 217 executes a predetermined informing program or an initial program. A message is informed from the display apparatus 240 and the speaker 250 to the plural persons 204 via the output control unit 221 and the input/output interface 211. This message may include contents that induce the plural persons 204 to perform gestures (for example, hand-waving motions, motions of game of rock, paper and scissors, or sign language). The informing program is selected from the informing program DB 216 by the informing program execution unit 217. The informing program DB 216 stores plural informing programs to be selected based on the environment or the attribute of a target person.

Next, the image of the plural persons 204 sensed by the stereo camera 230 is sent to the image recording unit 212 via the input/output interface 211, and an image history for a time in which gesture judgment is possible is recorded. The hand detection unit 213 detects a hand image from the image of the plural persons 204 sensed by the stereo camera 230. The hand image is detected based on, for example, the color, shape, and position. A hand of a person may be detected after the person is detected. Alternatively, only the hand may directly be detected.

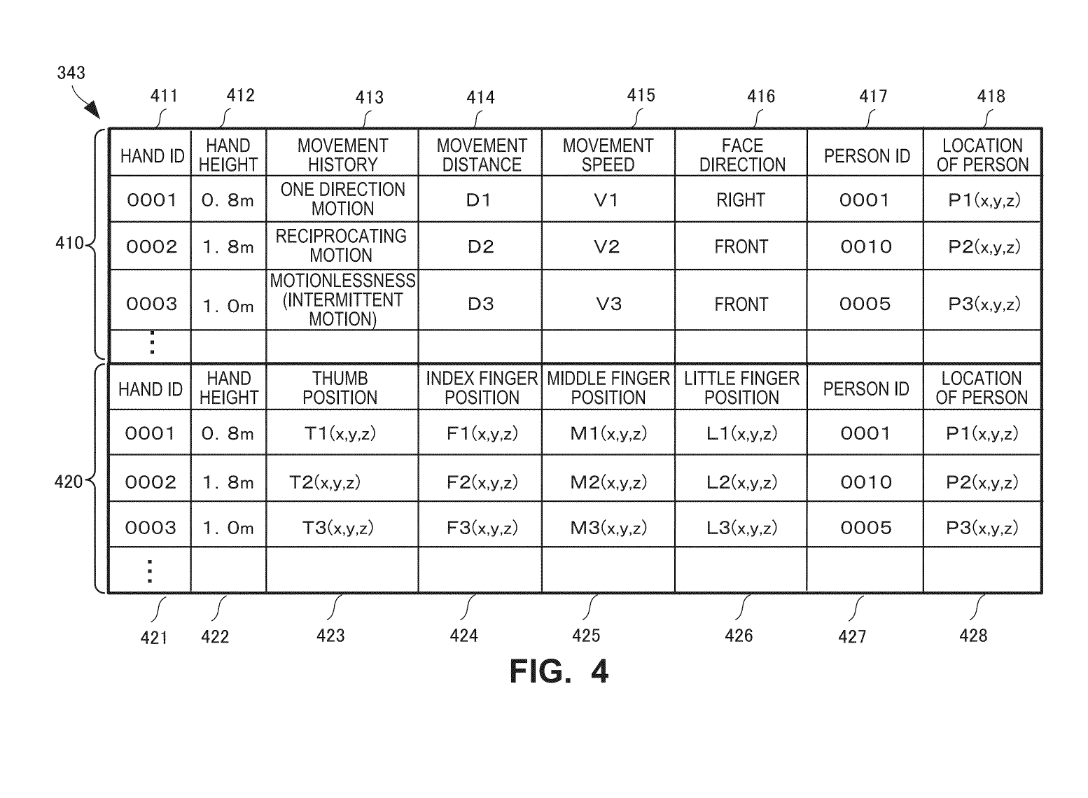

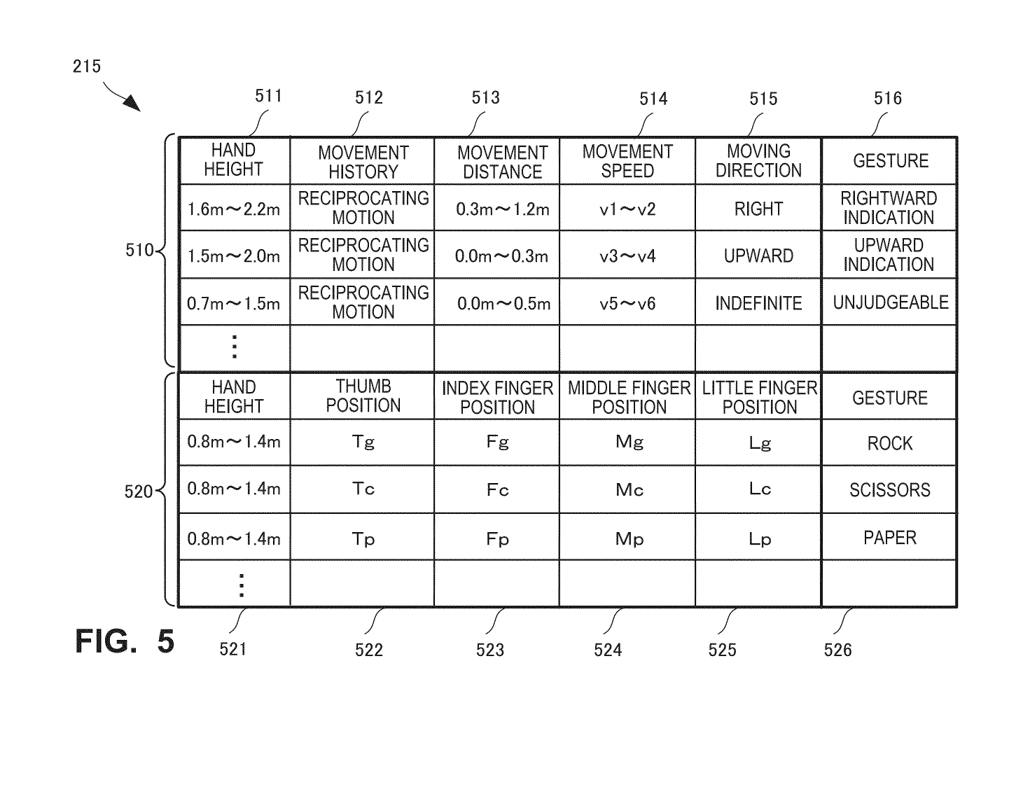

Based on the features (see FIG. 4) of the hand images in the image of the plural persons 204 detected by the hand detection unit 213, the gesture recognition unit 214 refers to the gesture DB 215 and judges the gesture of each hand. The gesture DB 215 stores the hand positions, finger positions, and time-series hand motions detected by the hand detection unit 213 in association with gestures (see FIG. 5).

The recognized result by the gesture recognition unit 214 is sent to the tendency judgment unit 219 to judge what tendency gestures have as a whole, performed by the plural persons 204. The tendency judgment unit 219 transmits the tendency as the judged result to the informing program execution unit 217. In accordance with the gesture performed by the plural persons 204 as a whole, the informing program execution unit 217 reads out an optimum informing program from the informing program DB 216 and executes it. The execution result is output from the display apparatus 240 and the speaker 250 via the output control unit 221 and the input/output interface 211.

### <Hardware Structure in Information Processing Apparatus>

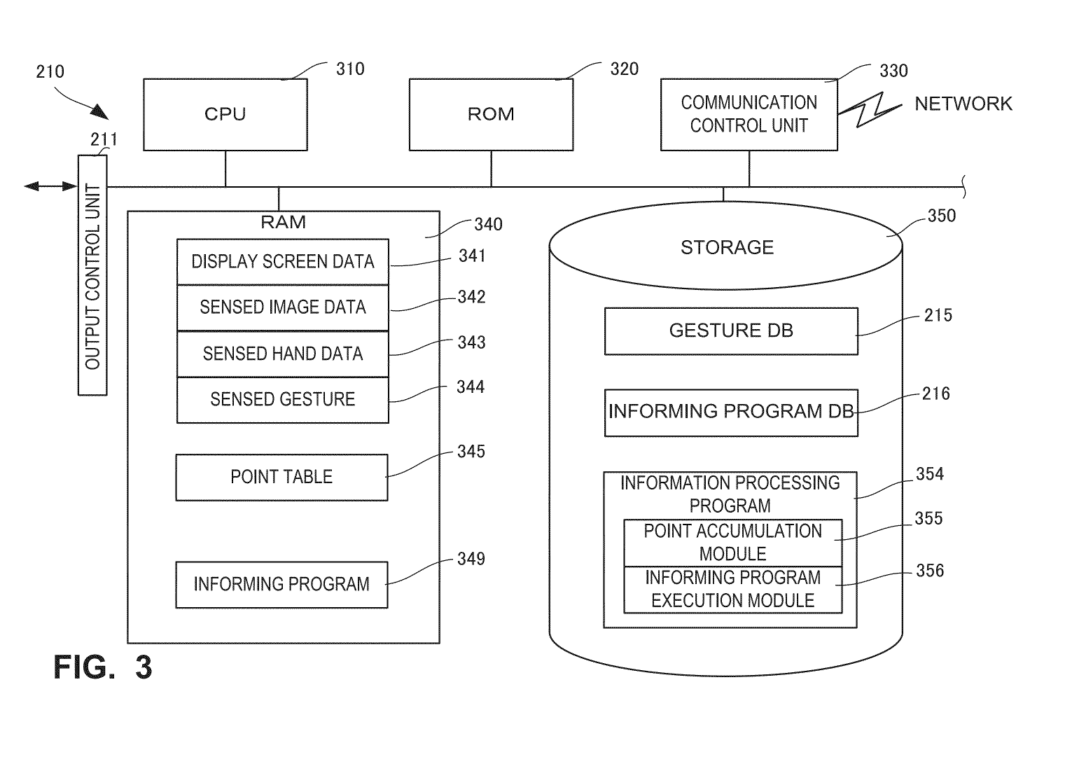

FIG. 3 is a block diagram showing the hardware structure of the information processing apparatus 210 according to this embodiment. Referring to FIG. 3, a CPU 310 is a processor for arithmetic control and implements each functional component shown in FIG. 2 by executing a program. A ROM 320 stores initial data, permanent data of programs and the like, and the programs. A communication control unit 330 communicates with an external apparatus via a network. The communication control unit 330 downloads informing programs from various kinds of servers and the like. The communication control unit 330 can receive a signal output from the stereo camera 230 or the display apparatus 240 via the network. Communication can be either wireless or wired. The input/output interface 211 functions as the interface to the stereo camera 230, the display apparatus 240, and the like, as in FIG. 2.

A RAM 340 is a random access memory used by the CPU 310 as a work area for temporary storage. An area to store data necessary for implementing the embodiment and an area to store an informing program are allocated in the RAM 340.

The RAM 340 temporarily stores display screen data 341 to be displayed on the display apparatus 240, image data 342 sensed by the stereo camera 230, and data 343 of a hand detected from the image data sensed by the stereo camera 230. The RAM 340 also stores a gesture 344 judged from the data of each sensed hand.

The RAM 340 also includes a point table 345, and calculates and temporarily saves the whole tendency of gestures obtained by sensing the plural persons 204 and a point used as the reference to select a specific person of interest.

The RAM 340 also includes the execution area of an informing program 349 to be executed by the information processing apparatus 210. Note that other programs stored in a storage 350 are also loaded to the RAM 340 and executed by the CPU 310 to implement the functions of the respective functional components shown in FIG. 2. The storage 350 is a mass storage device that nonvolatilely stores databases, various kinds of parameters, and programs to be executed by the CPU 310. The storage 350 stores the gesture DB 215 and the informing program DB 216 described with reference to FIG. 2 as well.

The storage 350 includes a main information processing program 354 to be executed by the information processing apparatus 210. The information processing program 354 includes a point accumulation module 355 that accumulates the points of gestures performed by the sensed plural persons, and an informing program execution module 356 that controls execution of an informing program.

Note that FIG. 3 illustrates only the data and programs indispensable in this embodiment but not general-purpose data and programs such as the OS.

### <Data Structures>

The structures of characteristic data used in the information processing apparatus 210 will be described below.

### <Structure of Data of Sensed Hands>

FIG. 4 is a view showing the structure of the data 343 of sensed hands.

FIG. 4 shows an example of hand data necessary for judging “hand-waving” or “game of rock, paper and scissors” as a gesture. Note that “sign language” and the like can also be judged by extracting hand data necessary for the judgment.

An upper stage 410 of FIG. 4 shows an example of data necessary for judging the “hand-waving” gesture. A hand ID 411 is added to each hand of sensed general public to identify the hand. As a hand position 412, a height is extracted here. As a movement history 413, “one direction motion”, “reciprocating motion”, and “motionlessness (intermittent motion)” are extracted in FIG. 4. Reference numeral 414 denotes a movement distance; and 415, a movement speed. The movement distance and the movement speed are used to judge whether a gesture is, for example, a “hand-waving” gesture or a “beckoning” gesture. A face direction 416 is used to judge whether a person is paying attention. A person ID 417 is used to identify the person who has the hand. As a location 418 of person, the location where the person with the person ID exists is extracted. The focus position of the stereo camera 230 is determined by the location of person. In three-dimensional display, the direction of the display screen toward the location of person may be determined. The sound contents or directivity of the speaker 250 may be adjusted. Note that although the data used to judge the “hand-waving” gesture does not include finger position data and the like, the finger positions may be added.

A lower stage 420 of FIG. 4 shows an example of data necessary for judging the “game of rock, paper and scissors” gesture. A hand ID 421 is added to the sensed hand of each person of general public to identify the hand. As a hand position 422, a height is extracted here. Reference numeral 423 indicates a three-dimensional thumb position; 424, a three-dimensional index finger position; 425, a three-dimensional middle finger position; and 426, a three-dimensional little finger position. A person ID 427 is used to identify the person who has the hand. As a location 428 of person, the location of the person with the person ID is extracted. Note that a ring finger position is not included in the example shown in FIG. 4 but may be included. When not only the data of fingers but also the data of a palm or back and, more specifically, finger joint positions are used in the judgment, the judgment can be done more accurately. Each data shown in FIG. 4 is matched with the contents of the gesture DB 215, thereby judging a gesture.

### <Structure of Gesture DB>

FIG. 5 is a view showing the structure of the gesture DB 215 according to the second embodiment. FIG. 5 shows DB contents used to judge a “direction indication” gesture on an upper stage 510 and DB contents used to judge the “game of rock, paper and scissors” gesture on a lower stage 520 in correspondence with FIG. 4. Data for “sign language” are also separately provided.

The range of “hand height” used to judge each gesture is stored in 511 on the upper stage 510. A movement history is stored in 512. A movement distance range is stored in 513. A movement speed range is stored in 514. A finger or hand moving direction is stored in 515. A “gesture” that is a result obtained by judgment based on the elements 511 to 515 is stored in 516. For example, a gesture satisfying the conditions of the first row is judged as a “rightward indication” gesture. A gesture satisfying the conditions of the second row is judged as an “upward indication” gesture. A gesture satisfying the conditions of the third row is judged as an “unjudgeable” gesture. To judge the “direction indication” gesture as accurately as possible, both the type of hand data to be extracted and the structure of the gesture DB 215 are added or changed depending on what kind of data is effective.

The range of “hand height” used to judge each gesture is stored in 521 of the lower stage 520. Since the lower stage 520 stores data used to judge the “game of rock, paper and scissors” gesture, the “hand height” ranges are identical. A gesture outside the height range is not regarded as the “game of rock, paper and scissors”. A thumb position is stored in 522, an index finger position is stored in 523, a middle finger position is stored in 524, and a little finger position is stored in 525. Note that the finger positions 522 to 525 are not the absolute positions of the fingers but the relative positions of the fingers. The finger position data shown in FIG. 4 are also used to judge the “game of rock, paper and scissors” gesture based on the relative position relationship by comparison. Although FIG. 5 shows no detailed numerical values, the finger position relationship of the first row is judged as “rock”. The finger position relationship of the second row is judged as “scissors”. The finger position relationship of the third row is judged as “paper”. As for the “sign language”, a time-series history is included, like the judgment of the “game of rock, paper and scissors”.

### <Structure of Recognized Result Table>

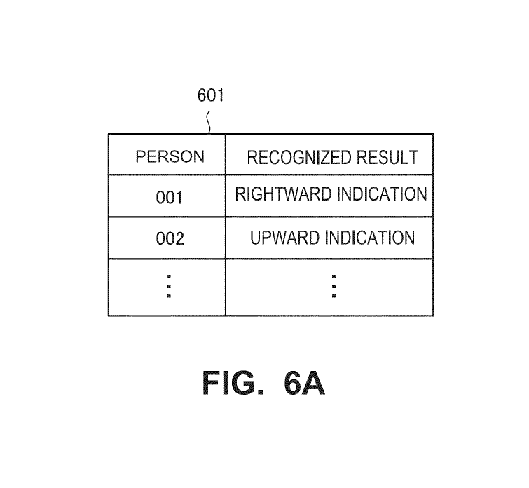

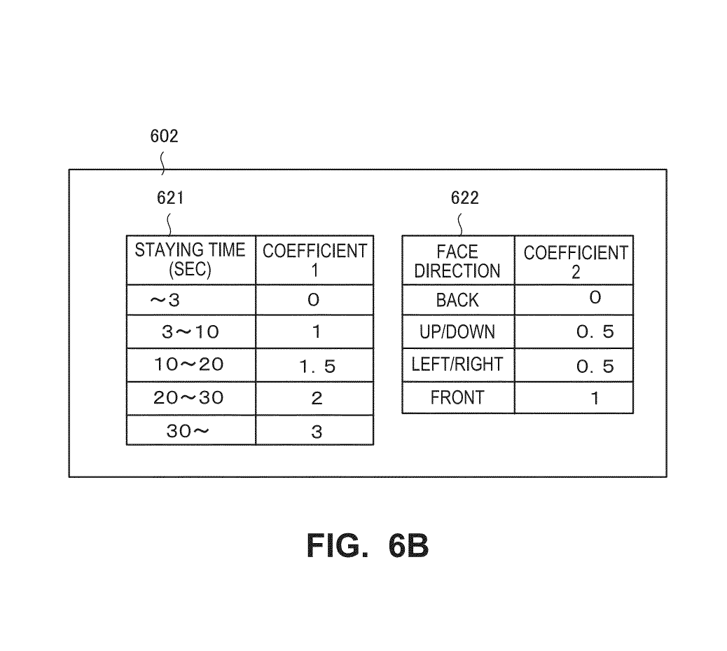

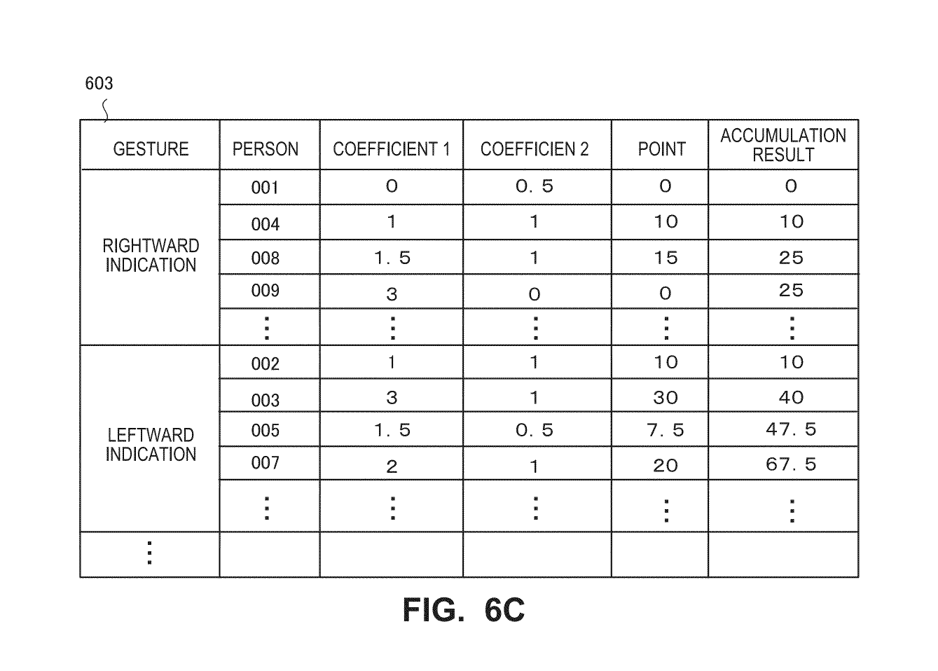

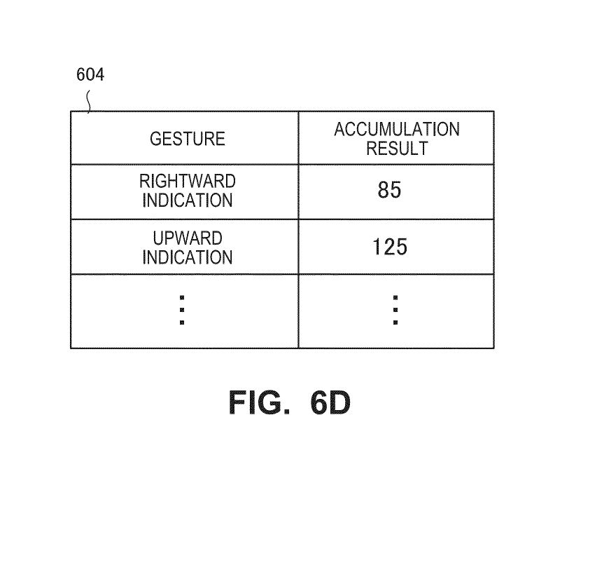

FIG. 6A is a view showing the structure of a recognized result table 601 representing the recognized result by the gesture recognition unit 214. As shown in FIG. 6A, the table 601 shows gestures (in this case, rightward indication and upward indication) as recognized results in correspondence with person IDs.

FIG. 6B is a view showing an attention level coefficient table 602 that manages the coefficients of attention level predetermined in accordance with the environment and the motion and location of a person other than gestures. A staying time table 621 and a face direction table 622 are shown here as coefficient tables used to judge, for each person, the attention level representing to what extent he/she is paying attention to the display apparatus 240. The staying time table 621 stores coefficients 1 used to evaluate, for each person, the time he/she stays in front of the display apparatus 240. The face direction table 622 stores coefficients 2 used to evaluate, for each person, the face direction viewed from the display apparatus 240. Other parameters such as the distance from the person to the display apparatus and the foot motion may also be used to judge the attention level.

FIG. 6C is a view showing a point accumulation table 603 for each gesture. The point accumulation table 603 represents how the points are accumulated for each gesture (in this case, rightward indication, upward indication, and the like) that is the result recognized by the gesture recognition unit 214.

The point accumulation table 603 stores the ID of each person judged to have performed the rightward indication gesture, the coefficients 1 and 2 representing the attention level of the person, the point of the person, and the point accumulation result. Since the basic point of the gesture itself is defined as 10, the coefficients 1 and 2 are added to 10 to obtain the point of each person. The accumulation result is a value obtained by adding all points of persons having IDs smaller than that of each person to points of each person.

FIG. 6D is a view showing a table 604 representing only accumulation results calculated using FIG. 6C. Performing such accumulation enables to judge what tendency gestures have as a whole, performed by the plural persons in front of the display apparatus 240. In the example of the table 604, the point of the group that has performed the upward indication gesture is high. It is therefore judged that the persons have the strong tendency to perform the upward indication gesture as a whole. The apparatus is controlled in accordance with the tendency by, for example, sliding the screen upward.

As described above, the consensus of group is judged not only by simple majority decision but also by weighting the attention level. This allows to implement a more impartial operation or digital signage never before possible.

### <Processing Sequence>

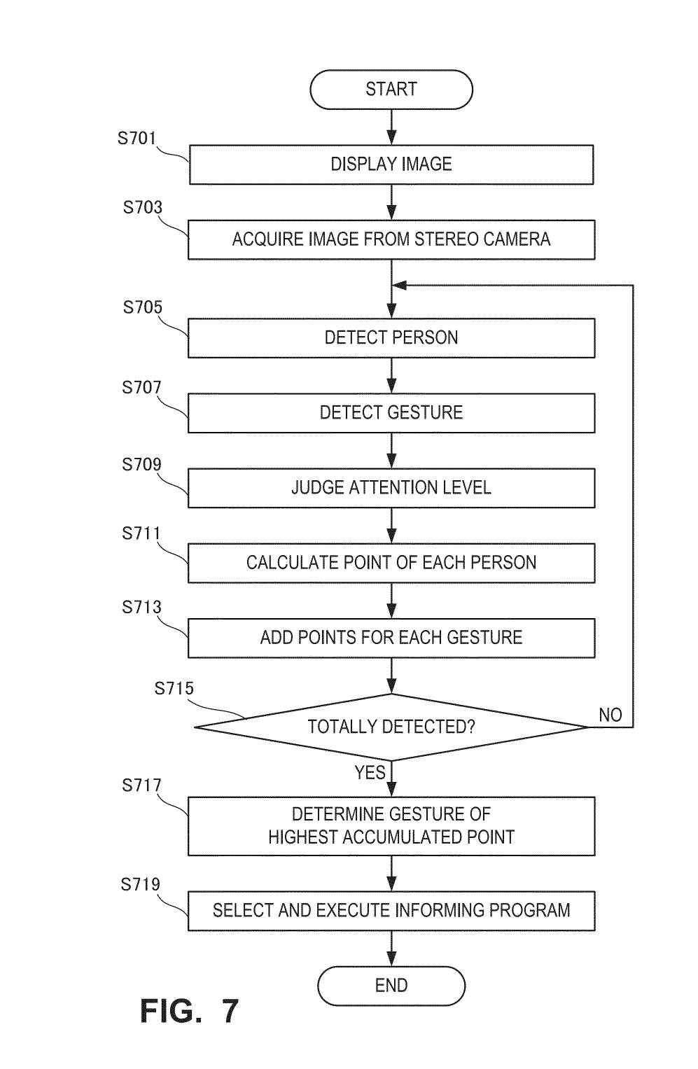

FIG. 7 is a flowchart showing the processing sequence of the image processing system 200. The CPU 310 shown in FIG. 3 executes the processing described in this flowchart using the RAM 340, thereby implementing the functions of the respective functional components shown in FIG. 2.

In step S701, the display apparatus 240 displays an image. The display apparatus 240 displays, for example, an image that induces general public to perform gestures. In step S703, the stereo camera 230 performs sensing to acquire an image. In step S705, persons are detected from the sensed image. In step S707, a gesture is detected for each person. In step S709, the “attention level” is judged, for each detected person, based on the staying time and the face direction.

The process advances to step S711 to calculate the point for each person. In step S713, the points are added for each gesture. In step S715, it is judged whether gesture detection and point addition have ended for all persons. The processing in steps S705 to S713 is repeated until point accumulation ends for all gestures.

When point accumulation has ended for all “gestures”, the process advances to step S717 to determine the gesture of the highest accumulated point. In step S719, an informing program is executed, judging that it is the consensus of group in front of the digital signage. Since the point of each individual remains in the point accumulation table 603, it is possible to focus on the person of the highest point. After such a person is identified, an informing program directed to only the person may be selected from the informing program DB 216 and executed.

### <Effects>

According to the above-described arrangement, communication with large audience can be done by one digital signage. For example, it is possible to display an image on a huge screen provided at an intersection or the like, sense the audience in front of the screen, and grasp their consensus or communicate with the whole audience.

Alternatively, the gestures and attention levels of audience may be judged in a campaign speech or a lecture at a university, and the image displayed on the monitor or the contents of the speech may be changed. Based on the accumulated point of public that have reacted, the display or sound can be switched to increase the number of persons who express interest.

### Third Embodiment

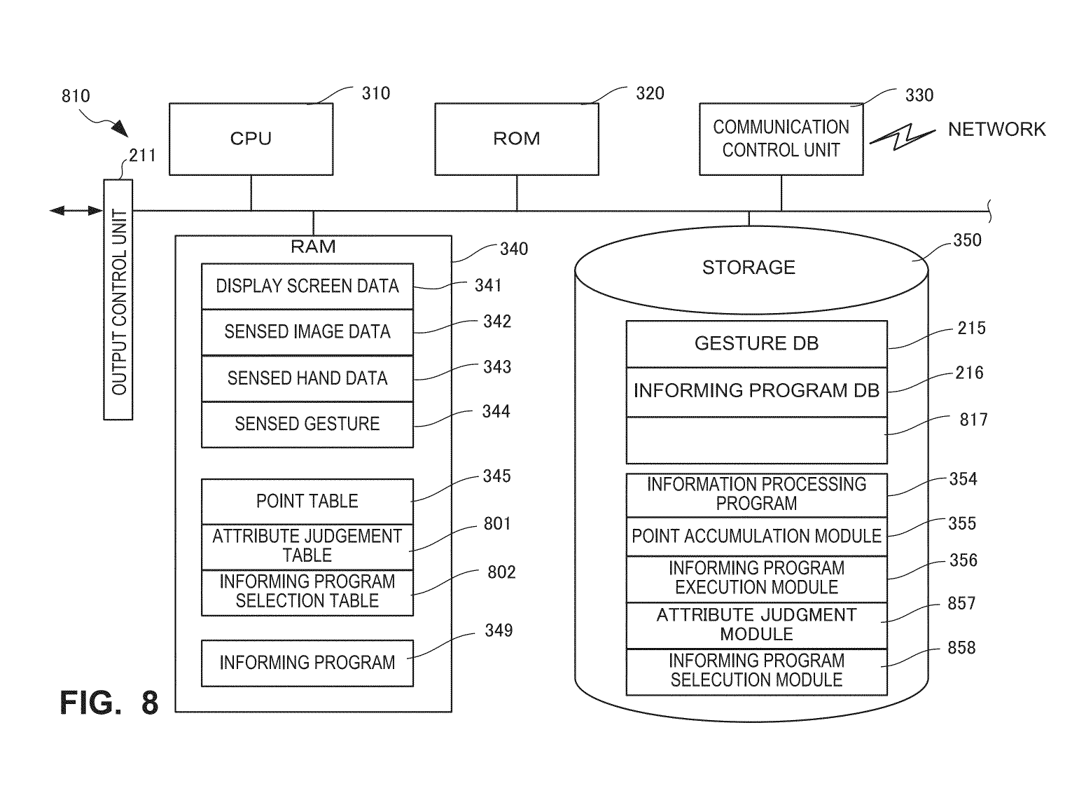

The third embodiment of the present invention will be described next with reference to FIGS. 8 to 12. FIG. 8 is a block diagram showing the arrangement of an information processing apparatus 810 according to this embodiment. The third embodiment is different from the second embodiment in that a RAM 340 includes an attribute judgment table 801 and an informing program selection table 802. The third embodiment is also different in that a storage 350 stores a person recognition DB 817, an attribute judgment module 857, and an informing program selection module 858.

In the third embodiment, the attribute (for example, gender or age) of a person judged to be a “target person” in accordance with on a gesture is judged based on an image from a stereo camera 230, and an informing program corresponding to the attribute is selected and executed, in addition to the second embodiment. Note that not only the attribute of the “target person” but also the clothing or behavior tendency, or whether he/she belongs to a group may be judged, and an informing program may be selected in accordance with the result. According to this embodiment, it is possible to cause the informing program to continuously attract the “target person”. The arrangements of the image processing system and the information processing apparatus according to the third embodiment are the same as in the second embodiment, and a description thereof will not be repeated. Added portions will be explained below.

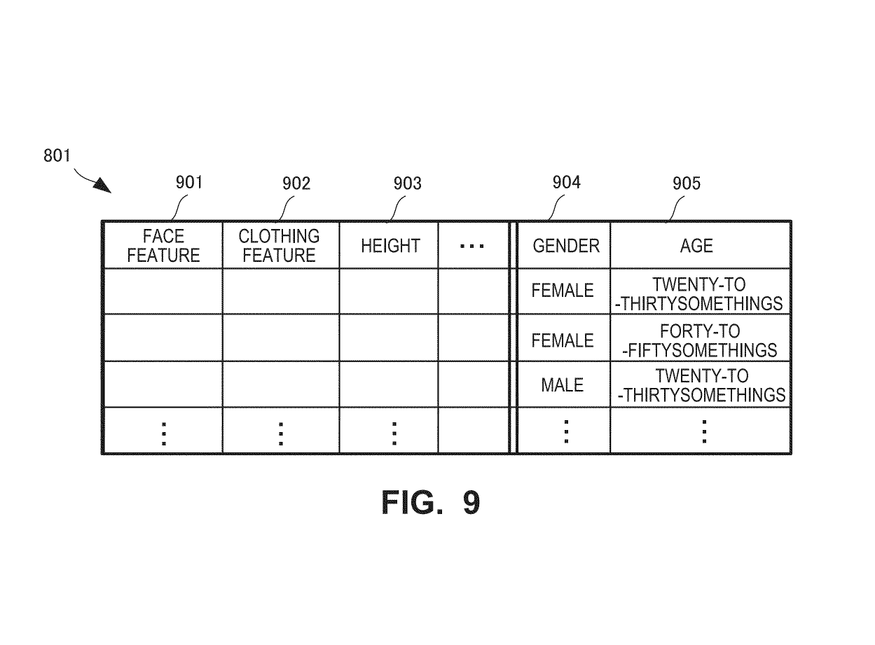

The attribute judgment table 801 is a table used to judge, based on a face feature 901, a clothing feature 902, a height 903, and the like, what kind of attribute (in this case, a gender 904 or an age 905) each person has, as shown in FIG. 9.

The informing program selection table 802 is a table used to determine, in accordance with the attribute of a person, which informing program is to be selected.

The person recognition DB 817 stores parameters for each predetermined feature to judge the attribute of a person. That is, points are predetermined in accordance with the face, clothing, or height, and the points are totalized to judge whether a person is a male or a female and to which age group he/she belongs.

The attribute judgment module 858 is a program module that judges the attribute of each person or a group of plural persons using the person recognition DB 817 and generates the attribute judgment table 801. The attribute judgment module 858 judges what kind of attribute (gender, age, or the like) each person who is performing a gesture in a sensed image has or what kind of attribute (couple, parent-child, friends, or the like) a group has.

The informing program selection module 857 selects an informing program corresponding to the attribute of a person or a group from an informing program DB 216.

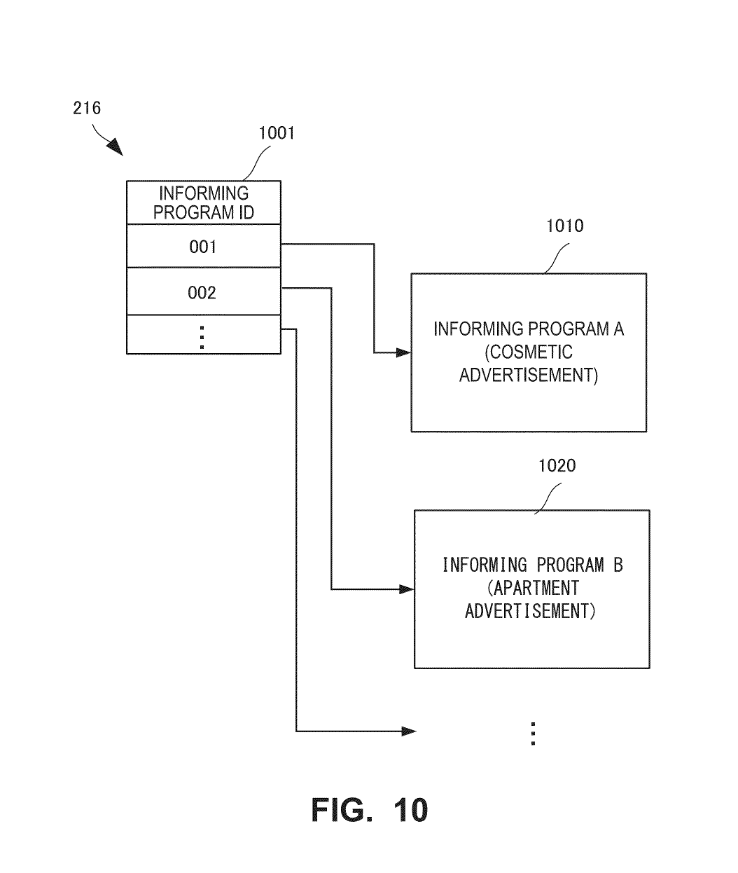

FIG. 10 is a block diagram showing the structure of the informing program DB 216. In FIG. 10, an informing program ID 1001 used to identify an informing program and serving as a key of readout is stored. An informing program A 1010 and an informing program B 1020 can be read out by the informing program IDs “001” and “002” in FIG. 10, respectively. In the example shown in FIG. 10, the informing program A is assumed to be a “cosmetic advertisement” program, and the informing program B is assumed to be an “apartment advertisement” program. An informing program corresponding to the attribute of the “target person” recognized using the person recognition DB 817 is selected from the informing program DB 216 and executed.

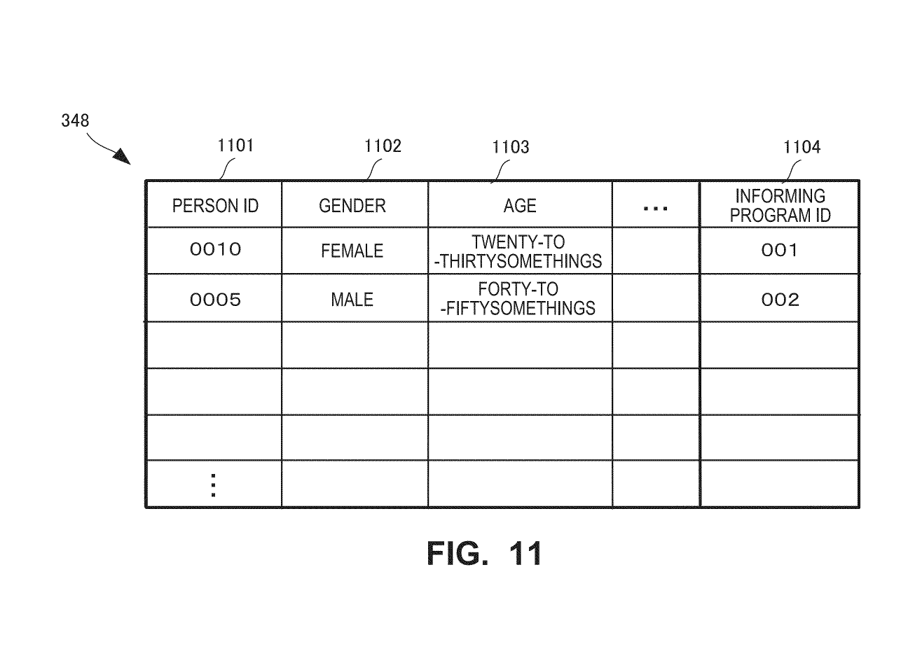

FIG. 11 is a view showing the structure of the informing program selection table 802. Referring to FIG. 11, reference numeral 1101 denotes a person ID of a “target person” judged by a gesture; 1102, a “gender” of the “target person” recognized by the person recognition DB 817; and 1103, an “age” of the “target person”. An informing program ID 1104 is determined in association with the attributes of the “target person” and the like. In the example shown in FIG. 11, the person with the person ID (0010) of the “target person” is recognized as a “female” in gender and twenty-to-thirtysomethings in “age”. For this reason, the informing program A of cosmetic advertisement shown in FIG. 10 is selected and executed. The person with the person ID (0005) of the “target person” is recognized as a “male” in gender and forty-to-fiftysomethings in “age”. For this reason, the informing program B of apartment advertisement shown in FIG. 10 is selected and executed. Note that the informing program selection is merely an example, and the However, the present invention is not limited to this.

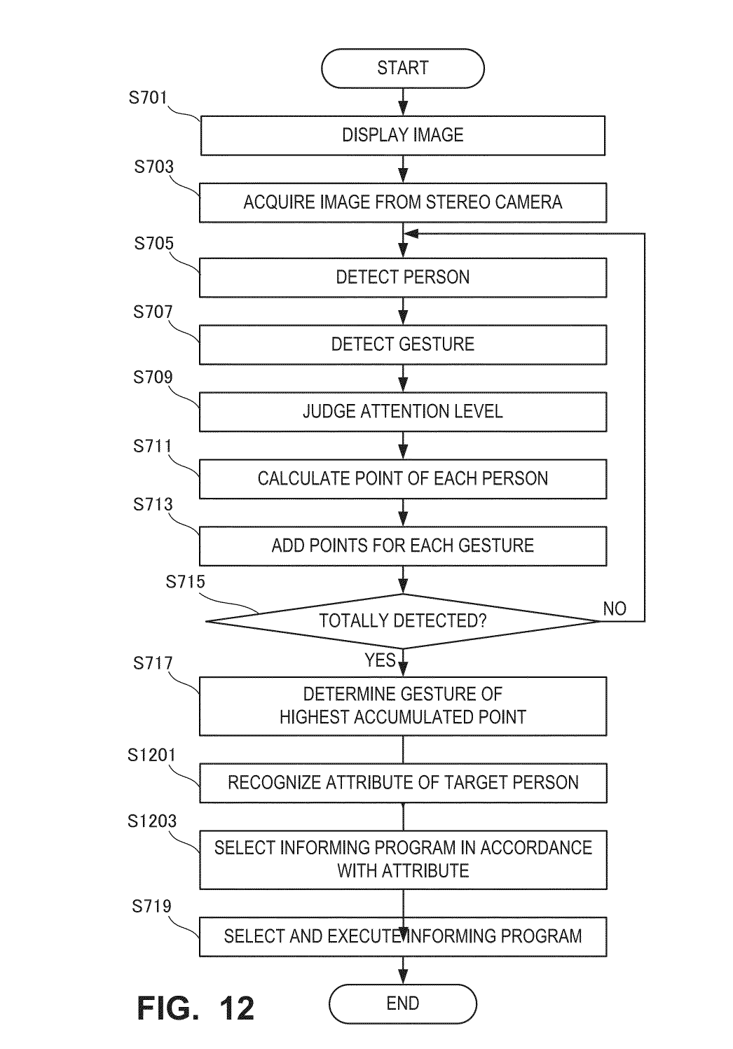

FIG. 12 is a flowchart showing the processing sequence of the information processing apparatus according to this embodiment. The flowchart shown in FIG. 12 is obtained by adding steps S1201 and S1203 to the flowchart shown in FIG. 7. The remaining steps are the same as in FIG. 7, and the two steps will be explained here.

In step S1201, the attribute of the “target person” is recognized by referring to the person recognition DB 817. In step S1203, an informing program is selected from the informing program DB 216 in accordance with the informing program selection table 802 shown in FIG. 11.

According to the above-described embodiment, advertisement can be informed in accordance with the attribute of the target person who has performed a gesture. For example, it is possible to play a game of rock, paper and scissors with plural persons and perform advertisement informing corresponding to the winner.

### Fourth Embodiment

In the second and third embodiments, processing by one information processing apparatus has been described. In the fourth embodiment, an arrangement will described in which plural information processing apparatuses are connected to an advertising information server via a network, and an informing program downloaded from the advertising information server is executed. According to this embodiment, the apparatuses can exchange information with each other. In addition, information can be concentrated to the advertising information server, and the advertisement/publicity can unitarily be managed. Note that the information processing apparatus of this embodiment can have the same functions as those of the information processing apparatus of the second or third embodiment, or some of the functions may be transferred to the advertising information server. When not only the informing program but also the operation program of the information processing apparatus is downloaded from the advertising information server according to the circumstances, a control method by gestures appropriate for the arrangement location is implemented.

Processing according to the fourth embodiment is basically the same as in the second and third embodiments regardless of the function dispersion. Hence, the arrangement of the image processing system will be explained, and a detailed description of the functions will be omitted.

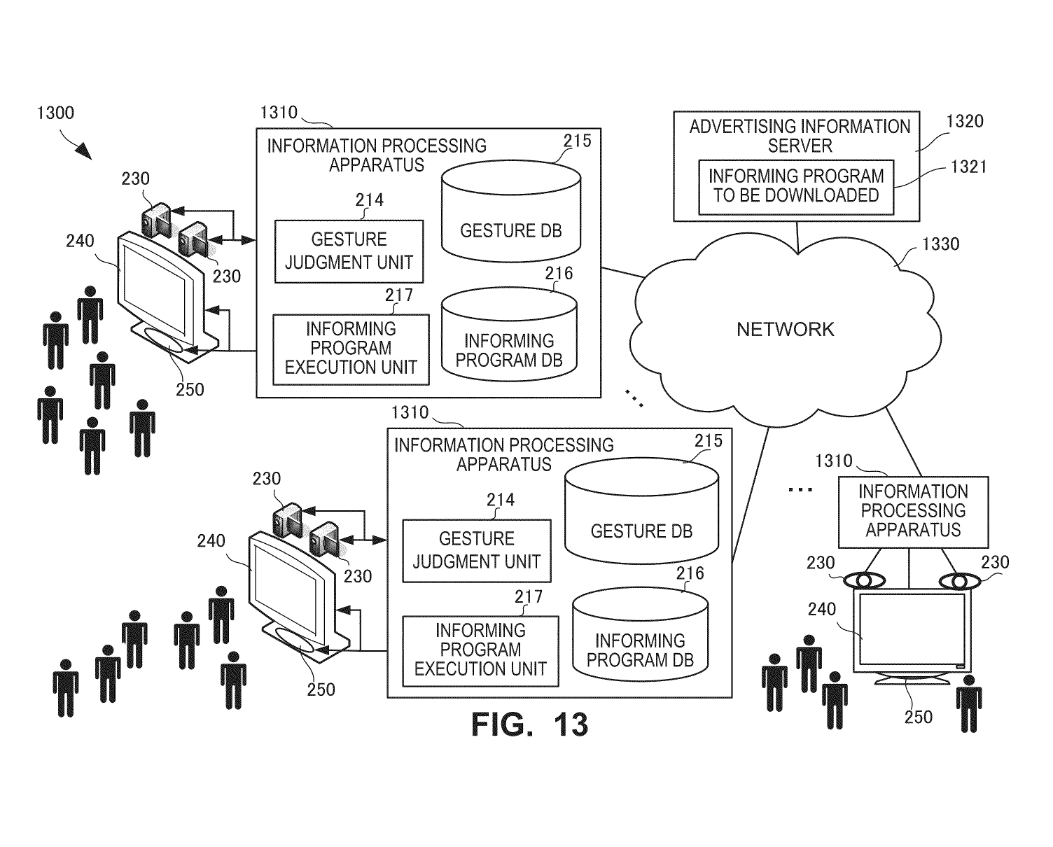

FIG. 13 is a block diagram showing the arrangement of an image processing system 1300 according to this embodiment. The same reference numerals as in FIG. 2 denote constituent elements having the same functions in FIG. 13. Different points will be explained below.

FIG. 13 shows three information processing apparatuses 1310. The number of information processing apparatuses is not limited. The information processing apparatuses 1310 are connected to an advertising information server 1320 via a network 1330. The advertising information server 1320 stores an informing program 1321 to be downloaded. The advertising information server 1320 receives information of each site sensed by a stereo camera 230 and selects an informing program to be downloaded. This enables to perform integrated control to, for example, cause plural display apparatuses 240 to display inducement images of associated gestures.

Note that FIG. 13 illustrates the information processing apparatuses 1310 each including a gesture judgment unit 214, a gesture DB 215, an informing program DB 216, and an informing program execution unit 217, as characteristic constituent elements. However, some of the functions may be dispersed to the advertising information server 1320 or another apparatus.

### Other Embodiments

While the present invention has been described above with reference to the embodiments, the present invention is not limited to the above-described embodiments. Various changes and modifications can be made for the arrangement and details of the present invention within the scope of the present invention, as is understood by those skilled in the art. A system or apparatus formed by combining separate features included in the respective embodiments in any form is also incorporated in the present invention.

The present invention can be applied to a system including plural devices or a single apparatus. The present invention can be applied to a case in which a control program for implementing the functions of the embodiments is supplied to the system or apparatus directly or from a remote site. Hence, the control program installed in a computer to implement the functions of the present invention by the computer, or a storage medium storing the control program or a WWW (World Wide Web) server to download the control program is also incorporated in the present invention.

This application claims the benefit of Japanese Patent Application No. 2010-251679, filed Nov. 10, 2010, which is hereby incorporated by reference herein in its entirety.

1-9. (canceled)

10. An image processing system comprising:
an image display unit that displays an image;
a sensing unit that senses an image of plural persons gathered in front of said image display unit;
a gesture recognition unit that recognizes, from the image sensed by said sensing unit, a gesture performed by each of the plural persons for a display screen displayed on said image display unit; and
a display control unit that makes the display screen transit based on a recognized result by said gesture recognition unit.

11. The image processing system according to claim 10, further comprising a judgment unit that judges, based on the recognized result by said gesture recognition unit, what tendency gestures have as a whole, performed by the plural persons,
wherein said display control unit makes the display screen transit based on a judged result by said judgment unit.

12. The image processing system according to claim 10, further comprising a judgment unit that judges, based on the recognized result by said gesture recognition unit, a gesture performed by a specific person out of the plural persons,
wherein said display control unit makes the display screen transit based on a judged result by said judgment unit.

13. The image processing system according to claim 11, wherein said judgment unit judges the tendency by weighting according to an attention level of each person for the gesture of each of the plural persons.

14. The image processing system according to claim 11, wherein said judgment unit judges what group-gesture tends to be performed within predetermined plural group-gestures by weighting according to an attention level of each person for the gesture of each of the plural persons.

15. The image processing system according to claim 13, wherein the attention level is calculated for each of the plural persons based on a face direction and a staying time in front of said image display unit.

16. The image processing system according to claim 14, wherein the attention level is calculated for each of the plural persons based on a face direction and a staying time in front of said image display unit.

17. An image processing apparatus comprising:
a gesture recognition unit that recognizes, from an image sensed by a sensing unit, a gesture performed by each of plural persons gathered in front of an image display unit for an image displayed on an image display unit; and
a display control unit that makes a display screen transit based on a recognized result by said gesture recognition unit.

18. An image processing method comprising:
an image display step of displaying an image on an image display unit;
a sensing step of sensing an image of plural persons gathered in front of the image display unit;
a gesture recognition step of recognizing, from the image sensed in the sensing step, a gesture performed by each of the plural persons for an image displayed on the image display unit; and
a display control step of making a display screen transit based on a recognized result in the gesture recognition step.

19. A storage medium storing an image processing program causing a computer to execute:
an image display step of displaying an image on an image display unit;
a gesture recognition step of recognizing, from an image of plural persons gathered in front of the image display unit, a gesture performed by each of the plural persons; and
a display control step of making a display screen transit based on a recognized result in the gesture recognition step.
